(19) United States
(12) Patent Application Publication
(10) Pub. No.: US 2026/0309213 A1
(43) Pub. Date: Oct. 8, 2026

(54) ACTUATOR FOR PROVIDING A TORQUE, SAID ACTUATOR COMPRISING A LINEAR DRIVE

(71) Applicant: Schaeffler Technologies AG & Co. KG, Herzogenaurach (DE)

(72) Inventors: Peter GREB, Ottersweier (DE); Laszlo MAN, Ottersweier (DE)

(73) Assignee: Schaeffler Technologies AG & Co. KG, Herzogenaurach (DE)

(21) Appl. No.: 19/491,464

(22) PCT Filed: Feb. 28, 2024
(86) PCT No.: PCT/DE2024/100163

§ 371 Date: Dec. 9, 2025

(30) Foreign Application Priority Data
Jun. 13, 2023 (DE) 10 2023 115 292.0

(51) Int. Cl. F16H 37/12; F16H 21/16; F16H 25/20

(52) U.S. Cl. CPC F16H 37/124; F16H 21/16; F16H 25/2015

(57) ABSTRACT

An actuator for providing a torque, the actuator including a linear drive and a gearbox for converting a linear movement into a rotational movement. The gearbox including a lever which rotationally drives a shaft to which the torque is to be applied. The gearbox also having a coupling element, the coupling element being connected to the linear drive via a first connection point and to the lever with a second connection point so that energy is transferred between the linear drive and the lever exclusively via the coupling element. The coupling element being rotatably mounted at both connection points.

### CROSS REFERENCE TO RELATED APPLICATIONS

This application is the U.S. National Phase of PCT Appln. No. PCT/DE2024/100163, filed Feb. 28, 2024, which claims priority to German Patent Application No. 10 2023 115 292.0, filed Jun. 13, 2023, the entire disclosures of which are incorporated by reference herein.

### TECHNICAL FIELD

The present disclosure relates to an actuator for providing a torque with a linear drive and a gearing for converting a linear movement into a rotational movement, the gearing including a lever which rotationally drives a shaft to which torque is to be applied.

### BACKGROUND

Such actuators are known from DE 102016207827 A1, with a non-linear actuating force for an actuating unit for an automatic transmission (preferably a PRND automatic transmission system) of a motor vehicle. For this purpose, a corresponding slide track is provided to generate the non-linearity. An actuator, preferably for clutch actuation with an articulated transmission between a linear transmission and a shaft, is known from WO 2015070850 A1. In general, such an actuator is already known from DE 102018116133 A1.

The present disclosure has the object of providing an actuator of the type in question with a non-linear characteristic curve in a simple manner.

### SUMMARY

This object of the disclosure is achieved by an actuator of the type in question with the features of claim 1.

According to the disclosure, the gearing of the actuator further has a coupling element, which is connected to the linear drive via a first connection point and to the lever via a second connection point, so that energy is transferred between the linear drive and the lever exclusively via the coupling element, and the coupling element is rotatably mounted at both connection points.

In addition to the lever and the linear drive, the coupling element provides a third component connecting them, which can be mounted in a particularly simple manner and enables a non-linear characteristic curve of the actuator by a corresponding energy transfer from the linear drive to the lever and thus to the shaft.

Furthermore, the lever is connected at a second lever end in a rotationally fixed manner to the shaft via a third connection point and at a first lever end rotatably to the coupling element via the second connection point, and the lever establishes a rigid connection between the two connection points. By adapting the positions of the connection points and the length of the coupling element, the non-linearity of the actuator can be easily adapted, since it is not the distance of the second lever end from the shaft that can be varied, but exclusively the transmitted torque or the corresponding rotational speed. In other words, the movement of the lever in space is defined by the housing-fixed position of the third connection point as a constraint, and the rotational speed and torque of the shaft are determined by the length of the coupling element in conjunction with its position on the linear drive.

Furthermore, according to the disclosure, the coupling element establishes a rigid connection between the first and second connection points, so that a linear movement of the first connection point by the linear drive results in a first pivoting movement of the second connection point about the first connection point as well as in a second pivoting movement of the second connection point about the third connection point, so that, due to the rotationally fixed connection of the lever to the shaft, a rotation of the shaft is caused by the second pivoting movement. The distance traveled by the second connection point is predetermined by the constraint of the rigid lever. By superposing the two pivots to a fixedly predetermined curve, the non-linearity of the rotational speed or the transmitted torque is predetermined accordingly.

According to the disclosure, the coupling element connects the lever and the linear drive to one another in such a way that the second connection point is moved along a trajectory, so that in a first working region around a first end point of the trajectory a movement of the first connection point is stepped up by the linear drive into a first rotational movement of the shaft and in a second working region around a second end point a movement of the first connection point is stepped down by the linear drive into a second rotational movement of the shaft, the first rotational movement covering a larger angular range with a smaller force transmission in a time interval than the second rotational movement. In this way, specific operating points and an intermediate transition region for the actuating force of the shaft can be defined, which correspond to a desired non-linearity of the actuation and which transition into one another.

In a first alternative according to the disclosure, at the second end point the coupling element is oriented perpendicular to the lever and to the movement axis of the linear drive and the lever is oriented parallel to the movement axis. With such an arrangement, force transmission is difficult. The force acting from the linear drive on the coupling element acts accordingly perpendicular to the tangent of the circular arc described by the second lever end, the transmitted torque is only very small, and thus a high rotational speed can be achieved. In this arrangement, the actuator is also self-locking. This is even more the case when friction points of the actuator are taken into account.

In a second arrangement according to the disclosure, alternatively or additionally, at the first end point the coupling element is oriented parallel to the movement axis of the linear drive and perpendicular to the lever. This results in maximum torque and minimum rotational speed. Therefore, the position of the actuator is also stable in this case.

In a further development of the disclosure, it is possible for a first, preferably housing-fixed, stop to be provided at the first end point for fixing the first end point and/or a second, preferably housing-fixed, stop to be provided at the second end point for fixing the second end point, and the second lever end is designed for the lever to strike against the first and/or second stop. In this way, the two stable end points of the actuator can be moved against securely and also held against vibrations.

The stops can be provided, for example, in an extension of a spindle of the linear drive on an actuator housing and in the opposite end position as a stop for the lever.

In particular, it is possible for the first and/or second stop to be formed integrally from an actuator housing.

The advantage of positioning the stops on the housing instead of limiting the linear adjustability of the linear drive within the linear drive is that a rotor bearing of the linear drive in a further development is positioned between the linear drive and the lever and thus the cumulated friction coefficient, which is mainly determined by the sliding friction coefficients within the linear drive and the stops and only negligibly by the rolling friction coefficient of the rotor bearing, does not fluctuate as much as a combination of only sliding friction points. This allows the required drive torque of the linear drive to be defined more precisely, which is necessary to ensure secure bracing in the stops.

The process for securely bracing the actuator at its end points consists in a slow/decelerated moving of the linear drive into a stop region. This means, for example, that a spindle which the linear drive comprises is moved against one of the stops and/or the lever is moved against the other stop. As the process continues, the linear drive continues to move in the same direction, or a corresponding spindle continues to rotate even after reaching the stop, and the linear drive, spindle or lever are moved with a defined torque which is certainly below the maximum possible torque of a motor or electric motor that drives the linear drive or spindle. This ensures that the bracing can be safely released even when boundary conditions (fluctuations in lubrication, temperature and power supply, etc.) have changed in order to be able to return to a normal operating state.

In order to enable movement against the stops in a particularly controlled manner for adjusting or calibrating the actuator, according to a further development, the first and/or second stop has/have a specific softness so that a predetermined linear movement of the linear drive is possible.

The required locking torque can also be predetermined to a reasonable value via the effective radius of the stops for the spindle or the lever or their variation during design.

Since no additional components are required for the stops, but only an adapted geometry of the actuator housing, the securing of the end stops can be implemented almost cost-neutrally.

Finally, the disclosure relates to an actuator comprising a linear drive and a gearing for converting a linear movement into a rotational movement. In principle, a person skilled in the art is well aware of various types of linear drives based on different principles, be they mechanical or hydraulic linear drives. The linear drive can be formed, for example, by a ball screw drive or a planetary roller screw drive. The linear movement can be provided by a nut on a spindle or by a spindle itself. The rotational movement of a shaft is generated by a lever that is connected in a rotationally fixed manner to the shaft. A coupling element establishes a rigid connection between the lever and the linear movement element (nut or spindle, etc.) of the linear drive. This means that the connection point of the coupling element on the linear drive is moved linearly exclusively along a straight path and the connection point of the coupling element on the lever is pivoted exclusively along a circular path with a predetermined radius r around the axis of the shaft, while the distance between the two connection points on the lever and on the linear drive always remains the same. In this way, a trajectory of the second connection point on the lever is realized which in a first working region provides a faster angular velocity at a lower torque and in a second working region provides a lower angular velocity at a higher torque to drive the shaft. There is a corresponding transition region between the two working regions.

In this way, the shaft can provide a rotational movement with a variable characteristic curve, i.e. in a first angular range with a greater angular velocity than in a second angular range and a correspondingly smaller torque in the first angular range than in the second angular range. This rotational movement can be used to actuate disconnect units, clutches, brakes or parking locks within a drive train of a motor vehicle or commercial vehicle.

The toggle lever mechanism described here creates a non-linear characteristic curve between the linear advance of the linear drive, e.g. a spindle travel, and the rotation of the lever or the drive force of the linear drive, or spindle force, and the torque of the lever. Thus, such an actuator is particularly suitable for actuating loads that also have a non-linear actuating force characteristic curve. An example of this would be the actuation of a parking lock.

This arrangement allows the shaft for actuating the loads to be positioned very close to the linear drive—significantly closer than if a comparably large actuating torque is generated solely by an actuating lever.

### BRIEF DESCRIPTION OF THE DRAWINGS

An exemplary embodiment of the disclosure, to which the disclosure is not limited and from which further features according to the disclosure may result, is shown in the following figures. In the figures:

FIG. 1 shows an actuator according to the disclosure with a partial sectional view,

FIG. 2 shows a symbolic representation of a trajectory of the lever for shaft actuation,

FIG. 3 shows an alternative arrangement of a coupling element between a lever and a spindle,

FIG. 4 shows an illustration of the torques generated by the actuator according to FIG. 3,

FIGS. 5 and 6 show an actuator according to FIG. 1 in a sectional view with a lever at a first end point and a second end point, and

FIG. 7 shows one half of an actuator housing.

### DETAILED DESCRIPTION

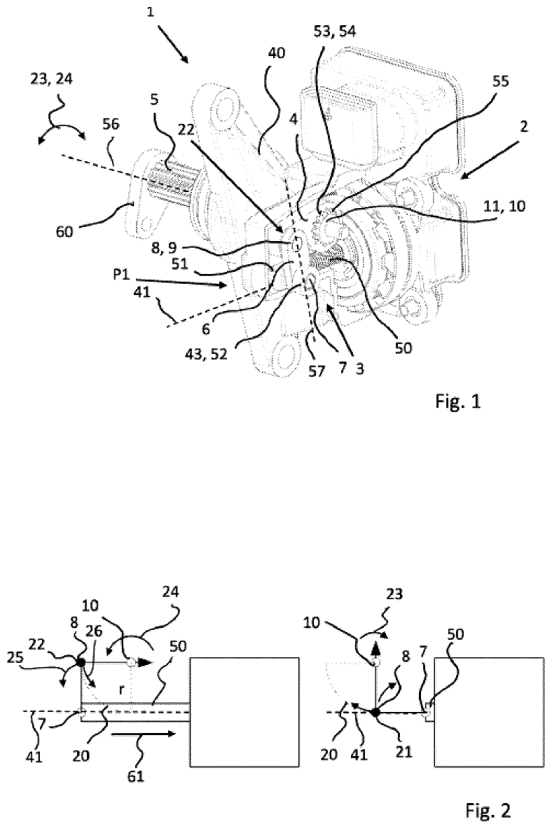

FIG. 1 shows an actuator 1 for converting a linear movement of a linear drive 2 into a rotational movement 23, 24 of a shaft 5.

The linear drive 2 comprises a spindle 50 for this purpose. The spindle 50 has an end cap 51, which is connected here on one side to a coupling element 6 via a support roller 52. Instead of just one support roller 52 on one side as shown here, support rollers on both sides can also each be connected to their own respective coupling elements.

The support roller 52 represents a first connection point 7 for the rotatable mounting of the coupling element 6.

The coupling element 6 is designed as a linearly extending, rigid sheet metal part which is connected at one end via the first connection point 7 to the spindle 50 and via a second connection point 8 at the second end to a lever 4. The coupling element 6 is also rotatably mounted on the lever 4 via the second connection point 8.

The lever 4 extends from its first lever end 9 with the second connection point 8 to a third connection point 10 at the second lever end 11. The lever 4 is connected to a shaft 5 in a rotationally fixed manner at the third connection point 10. For this purpose, the lever 4 has a hole 53 with an internal tooth system 54. The shaft 5 has a corresponding external tooth system 55 which engages in the internal tooth system 54. The shaft 5 is rotatably mounted in an actuator housing 40 and extends through the actuator housing 40 in the direction of a shaft axis 56. The shaft axis 56 runs perpendicular both to the movement axis 41 of the spindle 50 and to the direction of extension 57 of the coupling element 6.

Outside the actuator housing 40, the shaft 5 is connected to an actuating element 60. This can be an eccentric disc, a contour disc or similar, which is set to rotate by means of the shaft 5. A parking lock, a brake, a clutch or the like can be actuated via this actuating element 60 The spindle 50, the end cap 51, the coupling element 6 and the lever 4 are components of a gearing 3, which converts a linear movement of the spindle 50 of the linear drive 2 into a rotational movement 23, 24 of the shaft 5 to drive the actuating element 60.

In FIG. 1, the spindle 50 is located in a position P1, whereby the direction of extension 57 of the coupling element 6 is practically perpendicular to the movement axis 41 of the spindle 50 and to the lever 4. In position P1, the spindle 50 is practically fully extended and the second connection point 8 is located at a second end point 22. If the spindle 50 is retracted, the corresponding travel path of the spindle 50 is coupled with a smaller travel path of the second connection point 8 perpendicular thereto via the coupling element 6. That is, in this case, the linear movement of the linear drive 2 is converted into a second rotational movement 24. A maximum torque is transmitted to shaft 5 at a minimum rotational speed.

An illustration of the transmitted torque and the associated rotational speed is shown in FIG. 2. The second connection point 8 is located at the second end point 22 in the left part of FIG. 2, as also shown in FIG. 1, and is located at a first end point 21 in the right part. At the second end point 22 of the second connection point 8, the first connection point 7 of the coupling element 6 is located on the movement axis 41 of the spindle 50. A linear movement for retracting the spindle 50 in the direction 61 pulls the lever 4 via the second connection point 8 into a second rotational movement 24 around the third connection point 10. The second connection point 8 follows a trajectory 20 with the distance r between the second connection point 8 and the third connection point 10. This movement of the lever 4 is characterized by a minimum rotational speed and a maximum torque at the second end point 22.

In the right part of FIG. 2, the second connection point 8 is located at a first end point 21. In this case, the spindle 50 is retracted so far that the lever element 4 lies practically completely parallel to the spindle 50 on the movement axis 41. Extending the spindle 50 then results in a maximum rotational speed and minimum torque of the lever 4.

In the region between the two end points 21, 22, the lever 4 is thus driven with a non-linear torque characteristic curve. The shaft 5 is driven accordingly and the non-linear characteristic curve of the shaft 5 can be used to actuate a non-linear load, such as a parking lock.

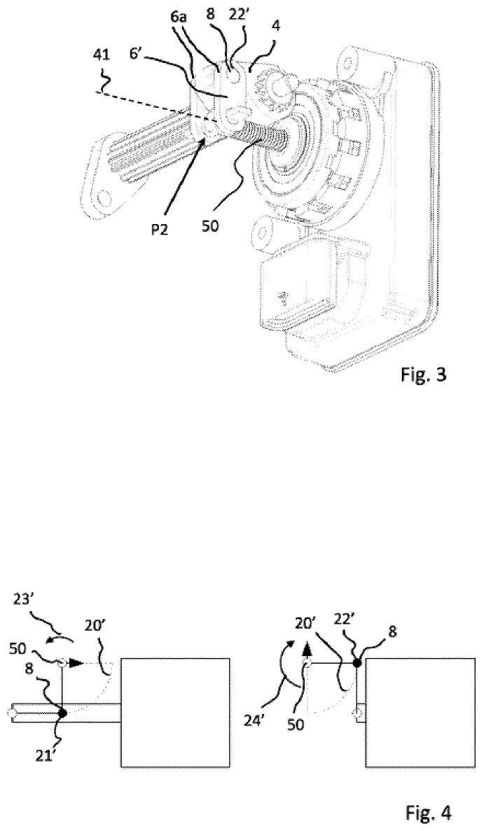

FIG. 3 shows an alternative arrangement of the coupling element 6 between the lever 4 and the spindle 50. The spindle 50 is in the retracted position P2 in this case, and the second connection point 8 is then located at the second end point 22′. In the parallel position of the coupling element 6, it is positioned such that it covers the spindle 50 in a direction of the movement axis 41. In contrast to the embodiment according to FIGS. 1 and 2, the coupling element 6 is tilted by 90°.

An illustration of the torques generated by this actuator can be found in FIG. 4. In this case, on the left side, a first end point 21′ of the second connection point 8 is shown, while on the right side, a second end point 22′ is shown accordingly. In between, the second connection point 8 is moved along the trajectory 20′. In this case also, a maximum torque is transmitted at the second end point 22′ (right) and a minimum torque is transmitted at the first end point 21′ to the shaft 50. Accordingly, the shaft 50 is subjected to a first rotational movement 23′ at the first end point 21′ and to a second rotational movement 24′ at the second end point 22′. The length of the arrows of the rotational movements 23′, 24′ symbolize the transmitted torque.

The trajectories 20 and 20′ of the two alternatives in FIGS. 2 and 4 are practically mirroring and otherwise do not differ. However, the directions of rotation at minimum and maximum torque of shaft 5 are switched, i.e. the rotational movements 23, 23′ and 24, 24′ are reversed and equal in magnitude in each case. In the first example of FIG. 2, the maximum torque is transmitted when the spindle 50 is retracted, whereas, in the second alternative according to FIG. 4, it is transmitted when the spindle 50 is extended.

The alternative embodiment of an actuator 1 according to FIG. 1, as shown in FIG. 3, also has a coupling element 6′ with two parallel partial coupling elements 6a on both sides of the spindle 50. Such a coupling element 6′ then also enables an actuation according to the alternative in FIG. 4.

However, the same applies in this case to the generation of the non-linear characteristic curve of shaft 5, as already described in FIG. 1.

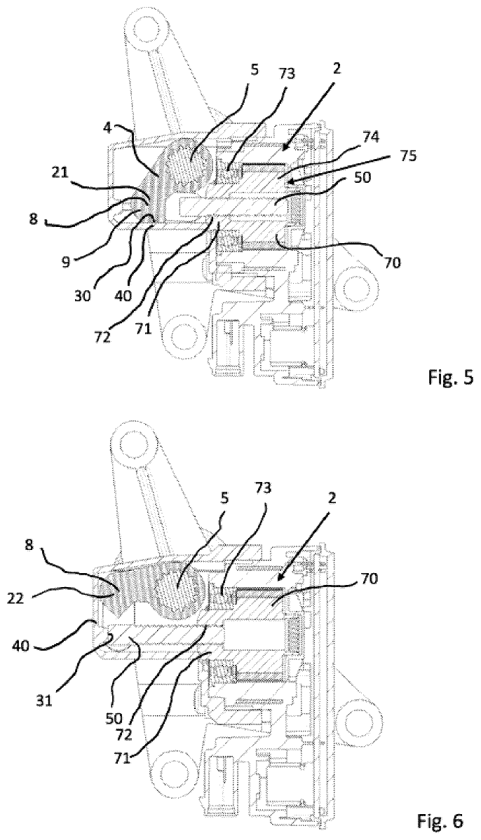

FIGS. 5 and 6 show an actuator according to FIG. 1, in which the drive by a spindle drive is shown in a sectional view and stops 30, 31 for the lever 4 and the spindle 50, respectively, are also provided on the actuator housing 40.

In FIG. 5, the lever 4, or the second connection point 8, is located at a first end point 21, and in FIG. 6 the second connection point 8 is shown at the second end point 22. In FIG. 6, a maximum torque is generated on the shaft 5 when the spindle 50 is retracted in the direction of the linear drive 2.

In FIG. 5, the lever 4 is positioned at the first end point 21 on the first stop 30. The first stop 30 is designed as an integrated component of the actuator housing 40. If a predetermined torque is now applied by the spindle 50 or by the spindle drive 70, which torque presses the lever 4 or the first lever end 9 with a predetermined stop force against the first stop 30, then the position of the lever 4 and thus the angular position of the shaft 5 can be clearly set and the actuator 1 can generally be secured against adjustments, for example due to vibrations.

In FIG. 6, the lever 4, or the second connection point 8, is located at the second end point 22. The second stop 31 is now provided for the spindle 50, or the end cap 51 of the spindle 50. Analogously, the spindle 50 can now be pressed against the second stop 31 with a predetermined torque. In this case also, the position of the lever 4 and thus the angular position of the shaft 5 can be clearly set and the actuator 1 can generally be secured against adjustments, for example due to vibrations.

FIGS. 5 and 6 further show that the spindle 50 is driven via a nut 71. This is connected to the spindle via a toothed point 72. Since the spindle 50 is received in a rotationally fixed manner in the actuator housing 40, the rotational movement of the nut 71 is converted accordingly into the linear movement of the spindle 50. The spindle 50 is supported on the actuator housing 40 via the nut 71 and a rotor bearing 73. The drive of the nut 71 is realized via a rotor 74 of an electric motor 75.

Since, as shown here, the rotor bearing 73 is positioned axially between the stops 30, 31 and the rotor 74, the torque which is necessary for a secure bracing of the lever 4 or the spindle 50 at the first or second stop 30, 31 can be set more precisely, since the cumulated friction coefficient, which is mainly determined by the sliding friction coefficients (spindle/nut, stop surfaces) and only negligibly by the rolling friction coefficient of the rotor bearing, does not fluctuate as much as a combination of only sliding friction points.

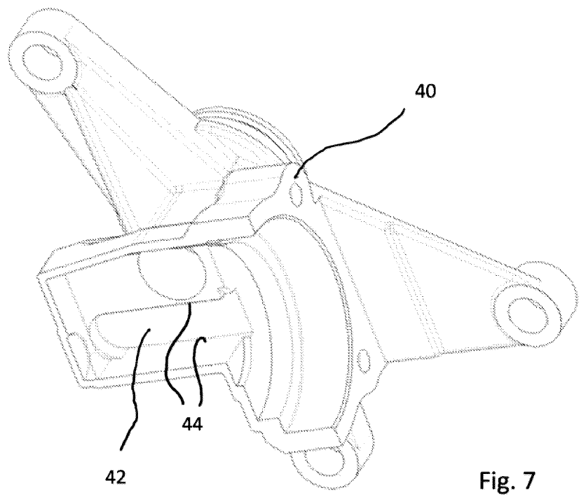

FIG. 7 shows a half of an actuator housing 40. The actuator housing 40 has an inner contour 42. This contour 42 is embossed into the actuator housing 40 parallel to the spindle 50 and serves to accommodate a bearing element 43. The bearing element 43 is positioned at one end of the spindle 50, as shown in FIG. 1, and supports the spindle 50 on the actuator housing 40. As shown in FIG. 1, it is preferably designed as a support roller 52. The bearing element 43 coincides with the first connection point 7. Preferably, this bearing element 43 consists of two support rollers 52, which are arranged around the articulated first connection point 7 between the spindle 50 and the coupling element 6, preferably on both sides at the end of the spindle 50, and which are supported on corresponding frame-fixed support surfaces 44 of the contour 42 in the actuator housing 40 and can roll there. In this way, the efficiency of actuator 1 can be improved (in principle, plain bearings on one or both sides are also conceivable). The support surfaces 44 preferably run parallel to the movement axis 41 of the spindle 50 or the linearly displaceable element of the linear drive 2.

By means of the actuator 1 shown here according to the toggle lever principle, a non-linear actuation characteristic curve can thus be easily realized on an actuating element 60 via a linear drive 2. The stops 30, 31 provided can be used to prevent an unintentional adjustment due to vibrations or similar, and can also ensure a defined position of the actuator 1, e.g. in the event of a power failure.

Secure actuation with good efficiency can be achieved via the support surfaces 44 in conjunction with the support rollers 52.

### LIST OF REFERENCE SIGNS

1 Actuator
2 Linear drive
3 Gearing
4 Lever
5 Shaft
6, 6′ Coupling element
6a Partial coupling element
7 First connection point
8 Second connection point
9 First lever end
10 Third connection point
11 Second lever end
20, 20′ Trajectory
21, 21′ First end point
22, 22′ Second end point
23, 23′ First rotational movement
24, 24′ Second rotational movement
25 First pivoting movement
26 Second pivoting movement
30 First stop
31 Second stop
40 Actuator housing
41 Movement axis
42 Contour
43 Bearing element
44 Support surfaces
50 Spindle
51 End cap
52 Support roller
53 Hole
54 Internal tooth system
55 External tooth system
56 Shaft axis
57 Direction of extension
60 Actuating element
61 Direction
70 Spindle drive
71 Nut
72 Toothed point
73 Rotor bearing
74 Rotor
75 Electric motor
P1, P2 Spindle positions

1. An actuator for providing a torque, comprising:
a linear drive and a gearing for converting a linear movement into a rotational movement, wherein the gearing comprises a lever which rotationally drives a shaft to which the torque is to be applied, the gearing further having a coupling element,
the coupling element being connected to the linear drive via a first connection point and to the lever via a second connection point, so that energy is transferred between the linear drive and the lever exclusively via the coupling element, and
the coupling element is rotatably mounted at both connection points, the lever being connected at a second lever end in a rotationally fixed manner to the shaft via a third connection point and at a first lever end rotatably to the coupling element via the second connection point, and the lever establishing a rigid connection between the two connection points,
the coupling element establishing a rigid connection between the first and second connection points, so that a linear movement of the first connection point by the linear drive results in a first pivoting movement of the second connection point about the first connection point, as well as in a second pivoting movement of the second connection point about the third connection point, so that, due to the rotationally fixed connection of the lever to the shaft, a rotation of the shaft is caused by the second pivoting movement, and
the coupling element connecting the lever and the linear drive to one another in such a way that the second connection point is moved along a trajectory, so that in a first working region around a first end point of the trajectory a movement of the first connection point is stepped up by the linear drive into a first rotational movement of the shaft and in a second working region around a second end point a movement of the first connection point is stepped down by the linear drive into a second rotational movement of the shaft, the first rotational movement covering a larger angular range with a smaller force transmission in a time interval than the second rotational movement,
wherein at the second end point the coupling element is oriented perpendicular to the lever and to a movement axis of the linear drive and the lever is oriented parallel to the movement axis or at the first end point the coupling element is oriented parallel to the movement axis of the linear drive and perpendicular to the lever.

2. The actuator according to claim 1, wherein a first housing-fixed stop is provided at the first end point for fixing the first end point and a second housing-fixed stop is provided at the second end point for fixing the second end point, and the first lever end is designed for the lever to strike against the first or second stop.

3. The actuator according to claim 1, wherein a second housing-fixed stop is provided for fixing the second end point, and a spindle or an end cap of the spindle is designed to strike against the second stop.

4. The actuator according to claim 2, wherein the first or second stop is formed integrally from an actuator housing.

5. The actuator according to claim 2, wherein the first or second stop have a specific softness, so that a predetermined linear movement of the linear drive is made possible.

6. An actuator for providing a torque, comprising:
a linear drive and a gearing for converting a linear movement into a rotational movement, wherein the gearing comprises a lever which rotationally drives a shaft to which the torque is to be applied, the gearing further having a coupling element;
the coupling element being connected to the linear drive via a first connection point and to the lever via a second connection point, so that energy is transferred between the linear drive and the lever exclusively via the coupling element; and
the coupling element is rotatably mounted at both connection points, the lever being connected at a second lever end in a rotationally fixed manner to the shaft via a third connection point and at a first lever end rotatably to the coupling element via the second connection point, and the lever establishing a rigid connection between the two connection points.

7. The actuator according to claim 6, further comprising the coupling element establishing a rigid connection between the first and second connection points, so that a linear movement of the first connection point by the linear drive results in a first pivoting movement of the second connection point about the first connection point, as well as in a second pivoting movement of the second connection point about the third connection point, so that, due to the rotationally fixed connection of the lever to the shaft, a rotation of the shaft is caused by the second pivoting movement.

8. The actuator according to claim 7, further comprising the coupling element connecting the lever and the linear drive to one another in such a way that the second connection point is moved along a trajectory, so that in a first working region around a first end point of the trajectory a movement of the first connection point is stepped up by the linear drive into a first rotational movement of the shaft and in a second working region around a second end point a movement of the first connection point is stepped down by the linear drive into a second rotational movement of the shaft.

9. The actuator according to claim 8, wherein the first rotational movement covers a larger angular range with a smaller force transmission in a time interval than the second rotational movement.

10. The actuator according to claim 9, wherein at the second end point the coupling element is oriented perpendicular to the lever and to a movement axis of the linear drive and the lever is oriented parallel to the movement axis or at the first end point the coupling element is oriented parallel to the movement axis of the linear drive and perpendicular to the lever.

11. The actuator according to claim 10, wherein a first housing-fixed stop is provided at the first end point for fixing the first end point and a second housing-fixed stop is provided at the second end point for fixing the second end point, and the first lever end is designed for the lever to strike against the first or second stop.

12. The actuator according to claim 10, wherein a second housing-fixed stop is provided for fixing the second end point, and a spindle or an end cap of the spindle is designed to strike against the second stop.

13. The actuator according to claim 11, wherein the first or second stop is formed integrally from an actuator housing.

14. The actuator according to claim 11, wherein the first or second stop have a specific softness, so that a predetermined linear movement of the linear drive is made possible.
